(19) United States
(12) Patent Application Publication
(10) Pub. No.: US 2026/0329289 A1
(43) Pub. Date: Oct. 22, 2026

(54) LOCAL TERRAIN PERCEPTION METHOD FOR LEGGED ROBOTS

(71) Applicant: HANGZHOU YUNSHENCHU TECHNOLOGY CO., LTD., Zhejiang (CN)

(72) Inventors: Junjie HUANG, Zhejiang (CN); Chao LI, Zhejiang (CN); Wei TANG, Zhejiang (CN); Xueliang HU, Zhejiang (CN); Zhen CHU, Zhejiang (CN); Shenhong CHEN, Zhejiang (CN); Qiuguo ZHU, Zhejiang (CN)

(73) Assignee: HANGZHOU YUNSHENCHU TECHNOLOGY CO., LTD., Zhejiang (CN)

(21) Appl. No.: 18/872,832

(22) PCT Filed: Dec. 1, 2023
(86) PCT No.: PCT/CN2023/135760

§ 371 Date: Dec. 9, 2024

(30) Foreign Application Priority Data
Nov. 15, 2023 (CN) 202311515887.3

(51) Int. Cl. G05D 1/606; G05D 1/242; G05D 1/246; G05D 109/12

(52) U.S. Cl. CPC G05D 1/606; G05D 1/242; G05D 1/2465; G05D 2109/12

(57) ABSTRACT

Disclosed is a local terrain perception method for legged robots, comprising following steps: S1, installing at least one lidar on legged robot, acquiring extrinsic parameters of lidar with respect to legged robot body coordinate system, and transforming point cloud scanned by lidar into legged robot body coordinate system; S2, performing motion distortion elimination on point cloud, transforming point cloud subjected to motion distortion elimination into legged robot gravity coordinate system, and reserving point cloud within set range; S3, performing dimension reduction on point cloud to obtain height information matrix; S4, performing hole-filling based on height information matrix; S5, eliminating influence of leg point clouds of legged robot on height matrix based on height information matrix; and S6, analyzing processed height information matrix, and calculating slope information matrixes and obstacle information matrix which are used for foothold planning and obstacle avoidance of legged robot.

### TECHNICAL FIELD

The invention belongs to the technical field of legged robots, and particularly relates to a local terrain perception method for legged robots.

### DESCRIPTION OF RELATED ART

Legged robots need to perceive terrain information below and around to carry out foothold planning and obstacle avoidance in uneven ground scenarios such as stairways. Due to the limitation of the field angle of point cloud sensors and the disturbance from the legs below the trunk of legged robots, it is difficult for the legged robots to directly observe the terrain below. At present, well-known legged robot manufacturers all over the world such as Boston Dynamics and AnyBotics adopt a cumulative terrain mergence method depending on odometers, that is, point cloud sensors of robots do not directly observe the terrain below and only observe the terrain in front or around. Robots estimate in real time their displacement and attitude angle by means of high-precision laser/visual odometers and obtain a complete terrain by merging multiple frames of historical point clouds in the movement process, that is, the current terrain below robots is scanned when the robots have not reached here yet. Such a scheme has the following defects: (1) the calculation quantity is large; (2) the requirement for the precision of odometers is high; (3) in specific scenarios, the odometers may fail to work, for example, the odometers may fail to work in excessively spacious or narrow scenarios, scenarios with a few structural features, dark scenarios, or texture-free scenarios.

### SUMMARY

To overcome the defects in the prior art, the invention provides a local terrain perception method for legged robots, which allows legged robots to directly observe the terrain below and around independent of high-precision odometers and realizes more accurate terrain perception.

The technical solution adopted by the invention to solve the technical problems is as follows: a local terrain perception method for legged robots comprises the following steps:
S1, installing at least one lidar on a legged robot, acquiring extrinsic parameters of the lidar with respect to a legged robot body coordinate system, transforming a point cloud scanned by the lidar into the legged robot body coordinate system, and regularly updating the point cloud scanned by the lidar;
S2, performing motion distortion elimination on the point cloud obtained in S1, transforming the point cloud subjected to the motion distortion elimination into a legged robot gravity coordinate system, and reserving the point cloud within a set range;
S3, performing dimension reduction on the point cloud obtained in S2 to obtain a height information matrix;
S4, performing hole-filling based on the height information matrix obtained in S3;
S5, eliminating an influence of leg point clouds of the legged robot on a height matrix based on the height information matrix obtained in S4; and
S6, analyzing the height information matrix processed in S5, and calculating slope information matrixes and an obstacle information matrix which are used for foothold planning and obstacle avoidance of the legged robot.

Further, S1 comprises the following sub-steps:
S11, installing at least one lidar on the legged robot to ensure that spaces around and below a trunk of the legged robot are within a scanning range of the lidars;
S12, defining the legged robot body coordinate system, wherein an origin of the legged robot body coordinate system is any position of the legged robot, an x-axis of the legged robot body coordinate system faces the front of the legged robot, a y-axis of the legged robot body coordinate system faces the left of the legged robot, a z-axis of the legged robot body coordinate system faces the top of the legged robot, the extrinsic parameters comprise a rotation matrix

$${R}_{{l}_{i}}^{b}$$

and a displacement vector

$${t}_{{l}_{i}}^{b} ,$$

b denotes the legged robot body coordinate system, and lᵢ denotes an i^{th} lidar;
S13, after point cloud data are received, transforming the point cloud from a lidar coordinate system into the legged robot body coordinate system by the following formula:

$$( \begin{matrix}{X}_{b} \\ {Y}_{b} \\ {Z}_{b} \\ 1\end{matrix} ) = ( \begin{matrix}{R}_{{l}_{i}}^{b} & {t}_{{l}_{i}}^{b} \\ 0 & 1\end{matrix} ) ( \begin{matrix}{X}_{{l}_{i}} \\ {Y}_{{l}_{i}} \\ {Z}_{{l}_{i}} \\ 1\end{matrix} )$$

where, Xₗ_{ᵢ}, Yₗ_{ᵢ}, and Zₗ_{ᵢ} are coordinates of a measurement point of the i^{th} lidar in the lidar coordinate system, and X_{b}, Y_{b} and Z_{b} are coordinates of the measurement point in the legged robot body coordinate system; and
S14, setting a period T for point cloud acquisition, and every one period T, merging the point clouds scanned by the lidars into a same point cloud after the point clouds are processed in S13.

Further,
S2 comprises the following sub-steps:
S21, installing an IMU on the legged robot, wherein the lidar is connected to a processor for acquiring an attitude angle of the IMU, and an installation attitude of the IMU is consistent with an attitude of the legged robot, such that the attitude of the legged robot is represented by the installation attitude of the IMU;
S22, estimating a displacement of the legged robot by means of a joint motor encoder and the IMU;
S23, inputting IMU attitude data not lower than 100 Hz and data of a legged robot displacement odometer to a point cloud processing module, and performing motion distortion elimination on the point cloud in conjunction with a timestamp of each point in the point cloud to make the timestamp of each point coincide with a timestamp of an end point of the point cloud:

$$( \begin{matrix}{X}_{b \_trans} \\ {Y}_{b\_trans} \\ {Z}_{b \_trans} \\ 1\end{matrix} ) = ( \begin{matrix}{R}_{{delta}_{j}} & {t}_{{delta}_{j}} \\ 0 & 1\end{matrix} ) ( \begin{matrix}{X}_{b} \\ {Y}_{b} \\ {Z}_{b} \\ 1\end{matrix} )$$

where, X_{b_trans}, Y_{b_trans} and Z_{b_trans} are coordinates of each point in the legged robot body coordinate system after the motion distortion elimination, and R_{delta}_{ⱼ} and t_{delta}_{ⱼ} respectively represent a rotation matrix and a displacement vector of the legged robot body coordinate system at the timestamp of a j^{th} point with respect to the legged robot body coordinate system at the timestamp of the end point of the point cloud;
S24, defining the legged robot gravity coordinate system, wherein an origin of the legged robot gravity coordinate system coincides with an origin of the legged robot body coordinate system, a z-axis of the legged robot gravity coordinate system is opposite to a gravity direction, an x-axis of the legged robot gravity coordinate system is perpendicular to the gravity direction and located in a same vertical plane as an x-axis of the legged robot body coordinate system, the y-axis is perpendicular to the x-axis and the z-axis, and a direction of the y-axis is defined based on a right-hand rule;
S25, transforming the point cloud subjected to the motion distortion elimination in S23 from the legged robot body coordinate system into the legged robot gravity coordinate system according to the attitude of the IMU corresponding to the timestamp of the end point of the point cloud:

$$( \begin{matrix}{X}_{g} \\ {Y}_{g} \\ {Z}_{g}\end{matrix} ) = {R}_{b}^{g} ( \begin{matrix}{X}_{b \_trans} \\ {Y}_{b\_trans} \\ {Z}_{b \_trans}\end{matrix} )$$

where, X_{g}, Y_{g} and Z_{g} are coordinates of each point in the point cloud transformed into the legged robot gravity coordinate system, and

$${R}_{b}^{g}$$

is a rotation matrix and is obtained by:

$${R}_{b}^{g} = {( {R}_{g}^{w} )}^{T} {R}_{b}^{w}$$

converting a Euler angle of the attitude of the IMU corresponding to the timestamp of the end point of the point cloud into a rotation matrix

$${R}_{b}^{w} ,$$

setting a heading angle in the Euler angle to zero, keeping a pitch angle and a roll angle unchanged, and then converting the Euler angle into a rotation matrix

$${R}_{g}^{w} ;$$

and
S26, performing pass-through filtering on the point cloud obtained in S25, reserving the point cloud within a target range in x, y and z directions of the legged robot gravity coordinate system, and discarding the point cloud outside the target range.

Because the same frame of point cloud of the lidar is not sampled at the same time and the lidar moves with the robot, original point cloud data are distorted, and the motion distortion needs to be eliminated by an algorithm; the legged robot gravity coordinate system for point cloud transformation ensures that the tilt angle of terrains such as the ground and slopes is the same as the actual tilt angle when the robot inclines; and only the point cloud within the set range is reserved, such that the calculation quantity is reduced.

Further, S3 comprises the following sub-steps:
S31, defining an m-row and m-column empty matrix for storing terrain height information around the legged robot, wherein the center of the matrix corresponds to an origin of the legged robot gravity coordinate system, each element of the matrix represents an n cm*n cm square grid, rows of the matrix denote an x-axis direction, and columns of the matrix denote a y-axis direction; and
S32, performing dimension reduction on the three-dimensional point cloud to obtain the height information matrix, looping through the point cloud obtained in S2, and determining, according to x and y coordinates of each point, an element corresponding to the point in the matrix; if the element is empty, assigning the element with a z coordinate of a current point as a height; if the element has been assigned with a value, comparing the value of the element and the z-coordinate of the current point; if the value of the element is smaller than the z-coordinate of the current point, updating the value of the element to the z-coordinate of the current point.

By performing dimension reduction on the point cloud to obtain the height information matrix, three-dimensional information is converted into two-dimensional information, thus reducing the data size; and disordered data are converted into ordered data, thus facilitating post-processing.

Further, S4 comprises the following sub-steps:
S41, searching for empty elements of the height matrix, using heights of elements with hole boundaries as candidate heights, and looping through the height information matrix obtained in S3; for an element with a height, if any one of front, back, left and right neighbors of the element is an element without a height, determining the current element as a hole-edge element, and accessing all elements one by one from the hole-edge element towards the neighbors until an element with a height is accessed or the number of accesses reaches a preset upper limit or an edge of the matrix is accessed; if an element with a height is accessed, comparing the height of the accessed element with the height of the current hole-edge element to obtain a height difference; if an absolute value of the height difference is less than a preset threshold, recording the smaller one in a hole recorder as a candidate empty element height, and recording row and column coordinates of all empty elements one by one in the access process;
S42, selecting a suitable height from multiple candidate heights; looping through the coordinates of all the empty elements in the hole recorder, wherein the coordinates of the empty elements in the hole recorder are possibly repetitive; accessing each empty element in the height information matrix; if the element is still empty, assigning the element with the selected candidate height; if the element has been assigned with a height, comparing the current height with the new candidate height, and selecting the smaller one; and
S43, repeating S41 and S42 until there is no hole to be filled or the number of times of cyclic processing reaches a preset upper limit.

Because the point cloud obtained by the lidar is not dense enough, there is no corresponding point cloud for part of grids of the height information matrix, and the height of empty grids is filled with reference to grids with heights around, thus facilitating subsequent processing.

Further, S5 comprises the following sub-steps:
S51, setting a range where legs of the legged robot are located and a corrosion size, and setting a row-column range for the height information matrix according to a size of the legged robot, wherein the row-column set for the height information matrix covers matrix elements updated by the leg point clouds of the legged robot, the number of rows ranges from r₁ to r₂, the number of columns ranges from c₁ to c₂, and the corrosion size s is set according to sizes of the legs;
S52, performing protrusion corrosion within a set range to remove terrain protrusions caused by the leg point clouds, copying a temporary matrix of the height information matrix, and updating elements in rows from r₁−s to r₂+s and columns from c₁−s to c₂+s of the temporary matrix to a minimum height in rows from −s to s and columns from −s to s around a current element to remove abnormal protrusions of some matrix elements caused by the leg point clouds;
S53, performing expansion compensation on a normal terrain, and updating the elements in the rows from r₁−s to r₂+s and the columns from c₁−s to c₂+s of the temporary matrix to a maximum height in the rows from −s to s and the columns from −s to s around the current element to compensate for a change of the normal terrain caused by S52; and
S54, updating the height information matrix, and copying a region defined by rows from r₁ to r₂ and columns from c₁ to c₂ in the temporary matrix to the original height information matrix.

By means of the above steps, the leg point clouds of the legged robot can be effectively prevented from being taken as information of the terrain below the legged robot, thus making perception more accurate.

Further, S6 comprises the following sub-steps:
S61, calculating a slope component in an x-direction of each element in the matrix, defining an m*m x-direction slope information matrix, looping through the height information matrix obtained in S5, and calculating a slope component slopeₓ in the x-direction of each element with a height:

$${slope}_{x} = \frac{( s l o p {e}_{x 1} + s l o p {e}_{x 2} )}{2}$$

$$s l o p {e}_{x 1} = \frac{h ( i , j ) - h ( i - 1 , j )}{n}$$

$${slope}_{x 2} = \frac{h ( i + 1 , j ) - h ( i , j )}{n}$$

where, n denotes a width of a square grid corresponding to each element, and h(i,j) is the height of the element in an i^{th} row and a j^{th} column; in a case where h(i−1,j) does not exist or does not have a height and h(i+1,j) has a height, slopeₓ=slopeₓ₂; in a case where h(i+1,j) does not exists or does not have a height and h(i−1,j) has a height, slopeₓ=slopeₓ₁; in a case where h(i−1,j) and h(i+1,j) do not exist or do not have a height, slopeₓ=0;

S62, calculating a slope component in a y-direction of each element in the matrix, defining an m*m y-direction slope information matrix, looping through the height information matrix obtained in S5, and calculating a slope component slope_{y} in the y-direction of each element with a height:

$${slope}_{y} = \frac{( {slope}_{y 1} + {slope}_{y 2} )}{2}$$

where, n denotes a width of a square grid corresponding to each element, and h(i,j) is the height of an element in an i^{th} row and a j^{th} column; in a case where h(i,j−1) does not exist or does not have a height and h(i,j+1) has a height, slope_{y}=slope_{y2}; in a case where h(i,j+1) does not exists or does not have a height and h(i,j−1) has a height, slope_{y}=slope_{y1}; in a case where h(i,j−1) and h(i,j+1) do not exist or do not have a height, slope_{y}=0;
S63, calculating an actual slope of each element in the matrix, defining an m*m actual slope information matrix, and updating the actual slope information matrix with the x-direction slope information matrix and the y-direction slope information:

slope(i,j)={square root over ((slopeₓ(i,j))²+(slope_{y}(i,j))²)}
where, slope(i,j) is a slope of an element in an i^{th} row and a j^{th} column of the actual slope information matrix, and slopeₓ(i,j) and slope_{y}(i,j) are respectively a slope of the element in the i^{th} row and the j^{th} column of the x-direction slope information matrix and a slope of the element in the i^{th} row and the j^{th} column of the y-direction slope information matrix;
S64, defining an m*m obstacle information matrix, and presetting a maximum walking step length l_Max, a maximum foothold height h_Max and a maximum foothold slope s_Max of the legged robot;
S65, calculating offline a matrix element access sequence in an obstacle analysis process; and
S66, sequentially accessing corresponding elements in the height information matrix and the slope information matrixes according to the access sequence obtained in S65, and analyzing whether grids where the elements are located are obstacles.
Further, in S65, with a center of the obstacle information matrix as a starting point, multiple search directions are preset and cover a 360° range; according to a size of the matrix, a search width in each search direction is preset as w, and a search step is set as n and is consistent with the width of the grid corresponding to one element; in each search direction, a segment which has a midpoint located at the center of the matrix and a width w and is perpendicular to the search direction is obtained first, and matrix elements corresponding to all grids where the segment passes are search elements obtained of step 0; and every time one search step is completed, the segment is moved by one step n in the search direction, elements corresponding to grids where the moved segment passes are search elements of a new step, and searching in each search direction will not be ended until the segment is moved completely out an area where the matrix is located.

Further, in S66, at the beginning of searching in each search direction, a historical search queue is established first, wherein a maximum length of the queue is l_queue=l_Max/n, is rounded down and indicates search steps corresponding to the maximum walking step length of the legged robot, and when a new value is added to a tail of the queue and the queue exceeds the maximum length, a value at a head of the queue will be deleted.

Further, in S66, an initial height is set as a zeroth value of the queue, wherein the initial height is an opposite number of a height of the legged robot standing on the ground; for a plurality of grids searched in each step, if a total height of the grids is greater than a maximum value +h_Max in the historical search queue, it is determined that the grids are obstacles, and corresponding elements of the obstacle information matrix are marked as 1; if the total height of the grids is less than or equal to the maximum value+h_Max in the historical search queue, it is determined that the grids are passable and are not obstacles, and in this case, if a corresponding slope is less than s_Max, it is determined that the grids are footholds, and the corresponding elements of the obstacle information matrix are marked as 0; if the corresponding slope is greater than s_Max, it is determined that the grids are passable and are not footholds, and the corresponding elements of the obstacle information matrix are marked as 0.1; and every time one search step is completed, a maximum height of all grids determined as footholds is added to the tail of the historical search queue.

The invention has the following beneficial effects: the local terrain perception method for legged robots is less independent on high-precision odometers, allows legged robot to directly observe the terrain below and around, and realizes more accurate terrain perception, thus facilitating planning of feasible paths of the legged robots and reducing the calculation quantity.

### BRIEF DESCRIPTION OF THE DRAWINGS

FIG. 1 is a schematic diagram of S42 according to the invention.

FIG. 2 is an effect diagram of S4 according to the invention.

FIG. 3 is an effect diagram of S5 according to the invention.

FIG. 4 is a first effect display image of S6 according to the invention.

FIG. 5 is a second effect display image of S6 according to the invention.

FIG. 6 is a first application effect picture of the invention in an actual scenario;

FIG. 7 is a second application effect picture of the invention in an actual scenario.

### DESCRIPTION OF THE EMBODIMENTS

To allow those skilled in the art to have a better understanding of the technical solutions of the invention, the technical solutions in the embodiments of the invention are clearly and completely described below in conjunction with accompanying drawings of the embodiments of the invention. Obviously, the embodiments in the following description are merely illustrative ones, and are not all possible ones of the invention. All other embodiments obtained by those ordinarily skilled in the art without creative labor should also fall within the protection scope of the invention.

A local terrain perception method for legged robots comprises the following steps:
S1, one, two or more lidars are fixedly installed on a legged robot, extrinsic parameters of the lidar with respect to a legged robot body coordinate system are acquired in advance, a point cloud scanned by the lidar is transformed into the legged robot body coordinate system, and the point cloud scanned by the lidar is updated regularly, that is, every a certain period, the point cloud scanned by the lidar is input to an algorithm module; and in case of multiple lidars, point clouds scanned by the lidars in this period are merged and then input to the algorithm module.

Specifically, S1 comprises the following sub-steps:
S11, at least one lidar is installed on the legged robot to ensure that spaces around and below a trunk of the legged robot are within a scanning range of the lidars; in this embodiment, a plurality of lidars used for scanning terrain point clouds are installed on the same legged robot, point cloud data are received by a same processor, the lidars should ensure that each scanning point has a timestamp, and installation positions of the lidars are reasonably distributed to make scanning areas of the lidars around and below the robot complementary;
S12, the legged robot body coordinate system is defined, wherein an origin of the legged robot body coordinate system is any position of the legged robot, an x-axis of the legged robot body coordinate system faces the front of the legged robot, a y-axis of the legged robot body coordinate system faces the left of the legged robot, a z-axis of the legged robot body coordinate system faces the top of the legged robot, the extrinsic parameters comprise a rotation matrix

$${R}_{{l}_{i}}^{b}$$

and a displacement vector

$${t}_{{l}_{i}}^{b} ,$$

b denotes the legged robot body coordinate system, and lᵢ denotes an i^{th} lidar; the extrinsic parameters may be obtained by calibration or designed directly by means of precise machines;
S13, after point cloud data are received, the point cloud is transformed from a lidar coordinate system into the legged robot body coordinate system by the following formula:

$$( \begin{matrix}{X}_{b} \\ {Y}_{b} \\ {Z}_{b} \\ 1\end{matrix} ) = ( \begin{matrix}{R}_{{l}_{i}}^{b} & {t}_{{l}_{i}}^{b} \\ 0 & 1\end{matrix} ) ( \begin{matrix}{X}_{{l}_{i}} \\ {Y}_{{l}_{i}} \\ {Z}_{{l}_{i}} \\ 1\end{matrix} )$$

where, Xₗ_{ᵢ}, Yₗ_{ᵢ} and Zₗ_{ᵢ} are coordinates of a measurement point of the i^{th} lidar in the lidar coordinate system, and X_{b}, Y_{b} and Z_{b} are coordinates of the measurement point in the legged robot body coordinate system; and
S14, a period T for point cloud acquisition is set, and every one period T, the point clouds scanned by the lidars are merged into a same point cloud after the point clouds are processed in S13.
S2, motion distortion elimination is performed on the point cloud obtained in S1, the point cloud subjected to the motion distortion elimination is transformed into a legged robot gravity coordinate system, and the point cloud within a set range is reserved.

Specifically, S2 comprises the following sub-steps:
S21, a nine-axis IMU (gyroscope) is installed on the legged robot, wherein the lidar is connected to a processor capable of acquiring three attitude angles of the IMU, and an installation attitude of the IMU is consistent with an attitude of the legged robot, such that the attitude of the legged robot is represented by the installation attitude of the IMU;
S22, a displacement of the legged robot is estimated by means of a joint motor encoder and the IMU;
S23, IMU attitude data not lower than 100 Hz and data of a legged robot displacement odometer are input to a point cloud processing module, and motion distortion elimination is performed on the point cloud in conjunction with a timestamp of each point in the point cloud to make the timestamp of each point coincide with a timestamp of an end point of the point cloud:

$$( \begin{matrix}{X}_{b \_trans} \\ {Y}_{b\_trans} \\ {Z}_{b \_trans} \\ 1\end{matrix} ) = ( \begin{matrix}{R}_{{delta}_{j}} & {t}_{{delta}_{j}} \\ 0 & 1\end{matrix} ) ( \begin{matrix}{X}_{b} \\ {Y}_{b} \\ {Z}_{b} \\ 1\end{matrix} )$$

where, X_{b_trans}, Y_{b_trans} and Z_{b_trans} are coordinates of each point in the legged robot body coordinate system after the motion distortion elimination, and R_{delta}_{ⱼ} and tdₑₗₜₐ_{ⱼ} respectively represent a rotation matrix and a displacement vector of the legged robot body coordinate system at the timestamp of a j^{th} point with respect to the legged robot body coordinate system at the timestamp of the end point of the point cloud;
S24, the legged robot gravity coordinate system is defined, wherein an origin of the legged robot gravity coordinate system coincides with an origin of the legged robot body coordinate system, a z-axis of the legged robot gravity coordinate system is opposite to a gravity direction, an x-axis of the legged robot gravity coordinate system is perpendicular to the gravity direction and located in a same vertical plane as an x-axis of the legged robot body coordinate system, the y-axis is perpendicular to the x-axis and the z-axis, and a direction of the y-axis is defined based on a right-hand rule;
S25, the point cloud subjected to the motion distortion elimination in S23 is transformed from the legged robot body coordinate system into the legged robot gravity coordinate system according to the attitude of the IMU corresponding to the timestamp of the end point of the point cloud:

$$( \begin{matrix}{X}_{b} \\ {Y}_{b} \\ {Z}_{b}\end{matrix} ) = {R}_{b}^{g} ( \begin{matrix}{X}_{b \_trans} \\ {Y}_{b\_trans} \\ {Z}_{b \_trans}\end{matrix} )$$

where, X_{g}, Y_{g} and Z_{g} are coordinates of each point in the point cloud transformed into the legged robot gravity coordinate system, and

$${R}_{b}^{g}$$

is a rotation matrix and is obtained as follows:

$${R}_{b}^{g} = {( {R}_{g}^{w} )}^{T} {R}_{b}^{w}$$

a Euler angle of the attitude of the IMU corresponding to the timestamp of the end point of the point cloud is converted into a rotation matrix

$${R}_{b}^{w} ,$$

a heading angle in the Euler angle is set to zero, a pitch angle and a roll angle remain unchanged, and then the Euler angle is converted into a rotation matrix

$${R}_{g}^{w} ;$$

and
S26, pass-through filtering is performed on the point cloud obtained in S25, the point cloud within a target range in x, y and z directions of the legged robot gravity coordinate system is reserved, and the point cloud outside the target range is discarded.
S3, dimension reduction is performed on the point cloud obtained in S2 to obtain a height information matrix.

Specifically, S3 comprises the following sub-steps:
S31, an m-row and m-column empty matrix for storing terrain height information around the legged robot is defined, wherein the center of the matrix corresponds to an origin of the legged robot gravity coordinate system, each element of the matrix represents an n cm*n cm square grid, rows of the matrix denote an x-axis direction, and columns of the matrix denote a y-axis direction; and
S32, dimension reduction is performed on the three-dimensional point cloud to obtain the height information matrix, the point cloud obtained in S2 is looped through, and an element corresponding to each point in the matrix is determined according to x and y coordinates of the point; if the element is empty, the element is assigned with a z coordinate of a current point as a height; if the element has been assigned with a value, the value of the element is compared with the z-coordinate of the current point; if the value of the element is smaller than the z-coordinate of the current point, the value of the element is updated to the z-coordinate of the current point.
S4, hole-filling is performed based on the height information matrix obtained in S3.

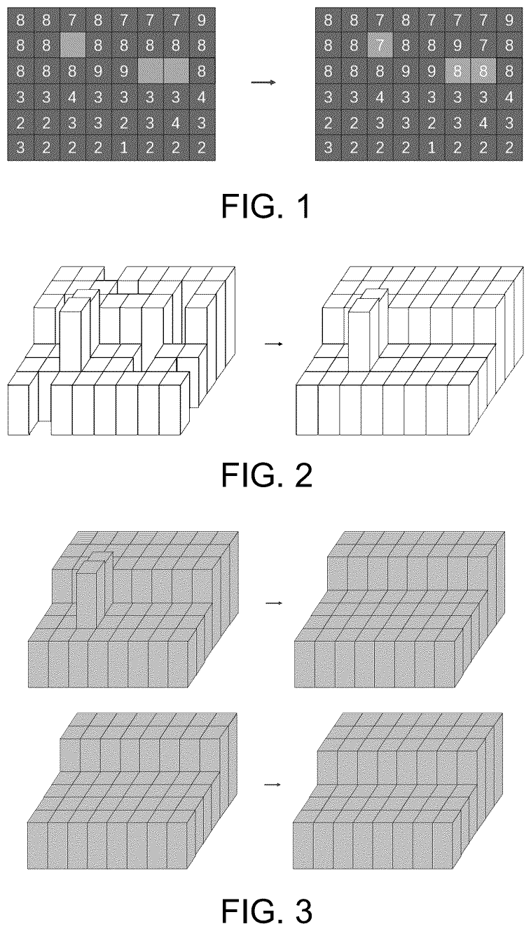

Specifically, S4 comprises the following sub-steps:
S41, empty elements of the height matrix are searched for, heights of elements with hole boundaries are used as candidate heights, and the height information matrix obtained in S3 is looped through; for an element with a height, if any one of front, back, left and right neighbors of the element is an element without a height, the current element is determined as a hole-edge element, and all elements are accessed one by one from the hole-edge element towards the neighbors until an element with a height is accessed or the number of accesses reaches a preset upper limit or an edge of the matrix is accessed; if an element with a height is accessed, the height of the accessed element is compared with the height of the current hole-edge element to obtain a height difference; if an absolute value of the height difference is less than a preset threshold, the smaller one is recorded in a hole recorder as a candidate empty element height, and row and column coordinates of all empty elements are recorded one by one in the access process;
S42, a suitable height is selected from multiple candidate heights; the coordinates of all the empty elements in the hole recorder are looped through, wherein the coordinates of the empty elements in the hole recorder are possibly repetitive; each empty element in the height information matrix is accessed; if the element is still empty, the element is assigned with the selected candidate height; if the element has been assigned with a height, the current height is compared with the new candidate height, and the smaller one is selected;
As shown in FIG. 1, x is rows, y is columns, elements (2,3), (3,6) and (3,7) are empty, and 8 exists on left and right sides of the element (2,3), so 8 is used as a candidate height; 7 and 8 exist on upper and lower sides of the element (2,3), assume a height difference threshold is 3, the height difference between 7 and 8 is less than the threshold, so 7 is used as a candidate height, and the smaller one 7 of the two candidate heights is used for filling in a hole corresponding to the element (2,3). For the elements (3,6) and (3,7), 8 and 9 exist on left and right sides, the height difference between the left and right sides is less than the threshold, so 8 is used as a candidate height; 6 and 4 exist on upper and lower sides, and a height difference between the upper and lower sides is greater than the threshold, so no candidate height is generated, and the unique candidate height 8 is used for filling in holes corresponding to the elements (3,6) and (3,7);
S43, S41 and S42 are repeated until there is no hole to be filled or the number of times of cyclic processing reaches a preset upper limit.

The height information matrix with a large quantity of holes obtained in S3 is filled by S4, and the effect is shown in FIG. 2; because the holes are filled, the height of the matrix at this moment includes terrain information and protrusions caused by legs of the legged robots.
S5, an influence of leg point clouds of the legged robot on a height matrix is eliminated based on the height information matrix obtained in S4.

Specifically, S5 comprises the following sub-steps:
S51, a range where legs of the legged robot are located and a corrosion size are set, and a row-column range is set for the height information matrix according to the size of the legged robot, wherein the row-column set for the height information matrix covers matrix elements updated by the leg point clouds of the legged robot, the number of rows ranges from r₁ to r₂, the number of columns ranges from c₁ to c₂, and the corrosion size s is set according to the sizes of the legs;
S52, protrusion corrosion is performed within a set range to remove terrain protrusions caused by the leg point clouds, a temporary matrix of the height information matrix is copied, and elements in rows from r₁−s to r₂+s and columns from c₁−s to c₂+s of the temporary matrix are updated to a minimum height in rows from −s to s and columns from −s to s around a current element to remove abnormal protrusions of some matrix elements caused by the leg point clouds;
S53, expansion compensation is performed on a normal terrain, and the elements in the rows from r₁−s to r₂+s and the columns from c₁−s to c₂+s of the temporary matrix are updated to a maximum height in the rows from −s to s and the columns from −s to s around the current element to compensate for a change of the normal terrain caused by S52; and
S54, the height information matrix is updated, and a region defined by rows from r₁ to r₂ and columns from c₁ to c₂ in the temporary matrix is copied to the original height information matrix.
In S5, the height matrix comprising both the terrain and leg protrusions is processed into a height matrix only comprising terrain information, and the effect achieved by the corrosion process and the expansion process is shown in FIG. 3.
S6, the height information matrix processed in S5 is analyzed, and slope information matrixes and an obstacle information matrix which are used for foothold planning and obstacle avoidance of the legged robot are calculated.

The slope information matrix can reflect the gradient of the position corresponding to each grid to prevent the robot from stepping on an improper position such as the edge of a stairway, and the obstacle information matrix can help the robot plan a feasible path.

Specifically, S6 comprises the following sub-steps:
S61, a slope component in an x-direction of each element in the matrix is calculated, an m*m x-direction slope information matrix is defined, the height information matrix obtained in S5 is looped through, and a slope component slopeₓ in the x-direction of each element with a height is calculated:

$${slope}_{x} = \frac{( {slope}_{x 1} + {slope}_{x 2} )}{2}$$

$${slope}_{x 1} = \frac{h ( i , j ) - h ( i - 1 , j )}{n}$$

$${slope}_{x 2} = \frac{h ( i + 1 , j ) - h ( i , j )}{n}$$

where, n denotes a width of a square grid corresponding to each element, and h(i,j) is the height of the element in an i^{th} row and a j^{th} column; in a case where h(i−1,j) does not exist or does not have a height and h(i+1,j) has a height, slopeₓ=slopeₓ₂; in a case where h(i+1,j) does not exists or does not have a height and h(i−1,j) has a height, slopeₓ=slopeₓ₁; in a case where h(i−1,j) and h(i+1,j) do not exist or do not have a height, slopeₓ=0;
S62, a slope component in a y-direction of each element in the matrix is calculated, an m*m y-direction slope information matrix is defined, the height information matrix obtained in S5 is looped through, and a slope component slope_{y} in the y-direction of each element with a height is calculated:

$${slope}_{y} = \frac{( {slope}_{y 1} + {slope}_{y 2} )}{2}$$

$$slop {e}_{y 1} = \frac{h ( i , j ) - h ( i , j - 1 )}{n}$$

$${slope}_{y2} = \frac{h ( i , j + 1 ) - h ( i , j )}{n}$$

where, n denotes a width of a square grid corresponding to each element, and h(i,j) is the height of an element in an i^{th} row and a j^{th} column; in a case where h(i,j−1) does not exist or does not have a height and h(i,j+1) has a height, slope_{y}=slope_{y2}; in a case where h(i,j+1) does not exists or does not have a height and h(i,j−1) has a height, slope_{y}=slope_{y1}; in a case where h(i,j−1) and h(i,j+1) do not exist or do not have a height, slope_{y}=0;
S63, an actual slope of each element in the matrix is calculated, an m*m actual slope information matrix is defined, and the actual slope information matrix is updated with the x-direction slope information matrix and the y-direction slope information:

slope(i,j)={square root over ((slopeₓ(i,j))²+(slope_{y}(i,j))²)}
where, slope(i,j) is a slope of an element in an i^{th} row and a j^{th} column of the actual slope information matrix, and slopeₓ(i,j) and slope_{y}(i,j) are respectively a slope of the element in the i^{th} row and the j^{th} column of the x-direction slope information matrix and a slope of the element in the i^{th} row and the j^{th} column of the y-direction slope information matrix;

S64, an m*m obstacle information matrix is defined, and a maximum walking step length l_Max, a maximum foothold height h_Max and a maximum foothold slope s_Max of the legged robot are preset;

S65, a matrix element access sequence in an obstacle analysis process is calculated offline, wherein in S65, with the center of the obstacle information matrix as a starting point, multiple search directions, such as 16 search directions, are preset and cover a 360° range, and the angle between every two adjacent search directions of the 16 search directions is 22.5°; according to the size of the matrix, a search width in each search direction is preset as w, and a search step is set as n and is consistent with the width of the grid corresponding to one element; in each search direction, a segment which has a midpoint located at the center of the matrix and a width w and is perpendicular to the search direction is obtained first, and matrix elements corresponding to all grids where the segment passes are search elements obtained of step 0; and every time one search step is completed, the segment is moved by one step n in the search direction, elements corresponding to grids where the moved segment passes are search elements of a new step, and searching in each search direction will not be ended until the segment is moved completely out an area where the matrix is located. Because calculations in this step are repetitive calculations, the same search sequence is adopted in all the calculations, and the search sequence of the grids is saved offline after the first calculation, such that the calculation quantity is reduced, and the real-time performance is improved;
S66, corresponding elements in the height information matrix and the slope information matrixes are sequentially accessed according to the access sequence obtained in S65, and whether grids where the elements are located are obstacles is analyzed;
in S66, at the beginning of searching in each search direction, a historical search queue is established first, wherein a maximum length of the queue is l_queue=l_Max/n, is rounded down and indicates search steps corresponding to the maximum walking step length of the legged robot, and when a new value is added to the tail of the queue and the queue exceeds the maximum length, a value at the head of the queue will be deleted;
in S66, an initial height is set as a zeroth value of the queue, wherein the initial height is an opposite number of the height of the legged robot standing on the ground; for a plurality of grids searched in each step, if a total height of the grids is greater than a maximum value+h_Max in the historical search queue, it is determined that the grids are obstacles, and corresponding elements of the obstacle information matrix are marked as 1; if the total height of the grids is less than or equal to the maximum value+h_Max in the historical search queue, it is determined that the grids are passable and are not obstacles, and in this case, if a corresponding slope is less than s_Max, it is determined that the grids are footholds, and the corresponding elements of the obstacle information matrix are marked as 0; if the corresponding slope is greater than s_Max, it is determined that the grids are passable and are not footholds, and the corresponding elements of the obstacle information matrix are marked as 0.1; and every time one search step is completed, a maximum height of all grids determined as footholds is added to the tail of the historical search queue. Because grids searched in different search directions are partially overlapped, in a case where an element in the obstacle information matrix is assigned with a value not for the first time, the previous value and the new value of the element need to be compared, and updating is performed only when the new value is less than the previous value.

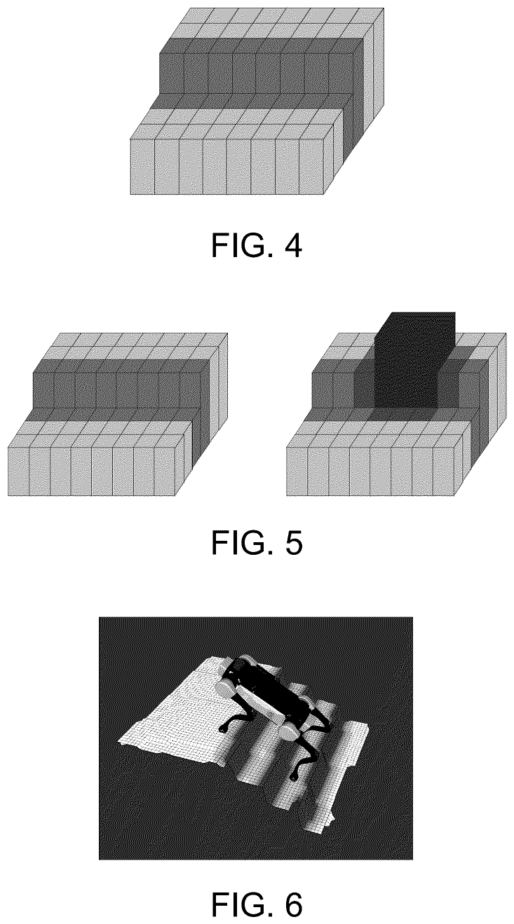

The slope of the position corresponding to each element is obtained by S61-S63, the effect is shown in FIG. 4, and the darker the color, the larger the slope; and whether there is an obstacle at the position corresponding to each element is determined by S64-S66, the black denotes an obstacle, and the effect in case of no obstacle on a stairway and the effect in case of an obstacle on a stairway are shown in FIG. 5.

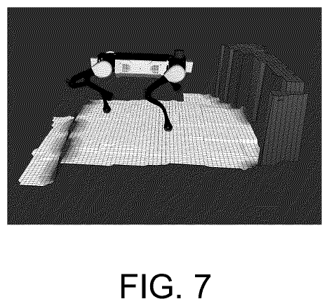

The effects of the invention in actual scenarios are shown in FIG. 6 and FIG. 7, and the legged robot can carry out obstacle avoidance and foothold planning based on the height information matrix, the slope information matrixes and the obstacle information matrix.

The above specific embodiments are used for explaining the invention rather than limiting the invention. Any amendments and modifications made to the invention based on the spirit of the invention and within the protection scope of the claims should also fall within the protection scope of the invention.

1. A local terrain perception method for legged robots, comprising following steps:
S1, installing at least one lidar on a legged robot, acquiring extrinsic parameters of the lidar with respect to a legged robot body coordinate system, transforming a point cloud scanned by the lidar into the legged robot body coordinate system, and regularly updating the point cloud scanned by the lidar;
S2, performing motion distortion elimination on the point cloud obtained in S1, transforming the point cloud subjected to the motion distortion elimination into a legged robot gravity coordinate system, and reserving the point cloud within a set range;
S3, performing dimension reduction on the point cloud obtained in S2 to obtain a height information matrix;
S4, performing hole-filling based on the height information matrix obtained in S3;
S5, eliminating an influence of leg point clouds of the legged robot on a height matrix based on the height information matrix obtained in S4; and
S6, analyzing the height information matrix processed in S5, and calculating slope information matrixes and an obstacle information matrix which are used for foothold planning and obstacle avoidance of the legged robot.

2. The local terrain perception method for legged robots according to claim 1, wherein S1 comprises following sub-steps:
S11, installing the at least one lidar on the legged robot to ensure that spaces around and below a trunk of the legged robot are within a scanning range of the lidars;
S12, defining the legged robot body coordinate system, wherein an origin of the legged robot body coordinate system is any position of the legged robot, an x-axis of the legged robot body coordinate system faces a front of the legged robot, a y-axis of the legged robot body coordinate system faces a left of the legged robot, a z-axis of the legged robot body coordinate system faces a top of the legged robot, the extrinsic parameters comprise a rotation matrix
$${R}_{{l}_{i}}^{b}$$
and a displacement vector
$${t}_{{l}_{i}}^{b} ,$$
b denotes the legged robot body coordinate system, and lᵢ denotes an i^{th} lidar;
S13, after point cloud data are received, transforming the point cloud from a lidar coordinate system into the legged robot body coordinate system by the following formula:
$$( \begin{matrix}{X}_{b} \\ {Y}_{b} \\ {Z}_{b} \\ 1\end{matrix} ) = ( \begin{matrix}{R}_{{l}_{i}}^{b} & {t}_{{l}_{i}}^{b} \\ 0 & 1\end{matrix} ) ( \begin{matrix}{X}_{{l}_{i}} \\ {Y}_{{l}_{i}} \\ {Z}_{{l}_{i}} \\ 1\end{matrix} )$$
where, Xₗ_{ᵢ}, Yₗ_{ᵢ} and Zₗ_{ᵢ} are coordinates of a measurement point of the i^{th} lidar in the lidar coordinate system, and X_{b}, Y_{b} and Z_{b} are coordinates of the measurement point in the legged robot body coordinate system; and
S14, setting a period T for point cloud acquisition, and every one period T, merging the point clouds scanned by the lidars into a same point cloud after the point clouds are processed in S13.

3. The local terrain perception method for legged robots according to claim 1, wherein S2 comprises following sub-steps:
S21, installing an IMU on the legged robot, wherein the lidar is connected to a processor for acquiring an attitude angle of the IMU, and an installation attitude of the IMU is consistent with an attitude of the legged robot, such that the attitude of the legged robot is represented by the installation attitude of the IMU;
S22, estimating a displacement of the legged robot by means of a joint motor encoder and the IMU;
S23, inputting IMU attitude data not lower than 100 Hz and data of a legged robot displacement odometer to a point cloud processing module, and performing motion distortion elimination on the point cloud in conjunction with a timestamp of each point in the point cloud to make the timestamp of each point coincide with a timestamp of an end point of the point cloud:
$$( \begin{matrix}{X}_{b \_trans} \\ {Y}_{b \_trans} \\ {Z}_{b \_trans} \\ 1\end{matrix} ) = ( \begin{matrix}{R}_{{delta}_{j}} & {t}_{{delta}_{j}} \\ 0 & 1\end{matrix} ) ( \begin{matrix}{X}_{b} \\ {Y}_{b} \\ {Z}_{b} \\ 1\end{matrix} )$$
where, X_{b_trans}, Y_{b_trans} and Z_{b_trans} are coordinates of each point in the legged robot body coordinate system after the motion distortion elimination, and R_{delta}_{ⱼ} and t_{delta}_{ⱼ} respectively represent a rotation matrix and a displacement vector of the legged robot body coordinate system at the timestamp of a j^{th} point with respect to the legged robot body coordinate system at the timestamp of the end point of the point cloud;
S24, defining the legged robot gravity coordinate system, wherein an origin of the legged robot gravity coordinate system coincides with an origin of the legged robot body coordinate system, a z-axis of the legged robot gravity coordinate system is opposite to a gravity direction, an x-axis of the legged robot gravity coordinate system is perpendicular to the gravity direction and located in a same vertical plane as an x-axis of the legged robot body coordinate system, the y-axis is perpendicular to the x-axis and the z-axis, and a direction of the y-axis is defined based on a right-hand rule;
S25, transforming the point cloud subjected to the motion distortion elimination in S23 from the legged robot body coordinate system into the legged robot gravity coordinate system according to the attitude of the IMU corresponding to the timestamp of the end point of the point cloud:
$$( \begin{matrix}{X}_{g} \\ {Y}_{g} \\ {Z}_{g}\end{matrix} ) = {R}_{b}^{g} ( \begin{matrix}{X}_{b \_trans} \\ {Y}_{b \_trans} \\ {Z}_{b \_trans}\end{matrix} )$$
where, X_{g}, Y_{g} and Z_{g} are coordinates of each point in the point cloud transformed into the legged robot gravity coordinate system, and
$${R}_{b}^{g}$$
is a rotation matrix and is obtained by:
$${R}_{b}^{g} = {( {R}_{g}^{w} )}^{T} {R}_{b}^{w}$$
converting a Euler angle of the attitude of the IMU corresponding to the timestamp of the end point of the point cloud into a rotation matrix
$${R}_{b}^{w} ,$$
setting a heading angle in the Euler angle to zero, keeping a pitch angle and a roll angle unchanged, and then converting the Euler angle into a rotation matrix
$${R}_{g}^{w} ;$$
and
S26, performing pass-through filtering on the point cloud obtained in S25, reserving the point cloud within a target range in x, y and z directions of the legged robot gravity coordinate system, and discarding the point cloud outside the target range.

4. The local terrain perception method for legged robots according to claim 1, wherein S3 comprises following sub-steps:
S31, defining an m-row and m-column empty matrix for storing terrain height information around the legged robot, wherein the center of the matrix corresponds to an origin of the legged robot gravity coordinate system, each element of the matrix represents an n cm*n cm square grid, rows of the matrix denote an x-axis direction, and columns of the matrix denote a y-axis direction; and
S32, performing dimension reduction on the three-dimensional point cloud to obtain the height information matrix, looping through the point cloud obtained in S2, and determining, according to x and y coordinates of each point, an element corresponding to the point in the matrix; if the element is empty, assigning the element with a z coordinate of a current point as a height; if the element has been assigned with a value, comparing the value of the element and the z-coordinate of the current point; if the value of the element is smaller than the z-coordinate of the current point, updating the value of the element to the z-coordinate of the current point.

5. The local terrain perception method for legged robots according to claim 1, wherein S4 comprises following sub-steps:
S41, searching for empty elements of the height matrix, using heights of elements with hole boundaries as candidate heights, and looping through the height information matrix obtained in S3; for an element with a height, if any one of front, back, left and right neighbors of the element is an element without a height, determining the current element as a hole-edge element, and accessing all elements one by one from the hole-edge element towards the neighbors until an element with a height is accessed or the number of accesses reaches a preset upper limit or an edge of the matrix is accessed; if an element with a height is accessed, comparing the height of the accessed element with the height of the current hole-edge element to obtain a height difference; if an absolute value of the height difference is less than a preset threshold, recording the smaller one in a hole recorder as a candidate empty element height, and recording row and column coordinates of all empty elements one by one in the access process;
S42, selecting a suitable height from multiple candidate heights; looping through the coordinates of all the empty elements in the hole recorder, wherein the coordinates of the empty elements in the hole recorder are possibly repetitive; accessing each empty element in the height information matrix; if the element is still empty, assigning the element with the selected candidate height; if the element has been assigned with a height, comparing the current height with the new candidate height, and selecting the smaller one; and
S43, repeating S41 and S42 until there is no hole to be filled or the number of times of cyclic processing reaches a preset upper limit.

6. The local terrain perception method for legged robots according to claim 1, wherein S5 comprises following sub-steps:
S51, setting a range where legs of the legged robot are located and a corrosion size, and setting a row-column range for the height information matrix according to a size of the legged robot, wherein the row-column set for the height information matrix covers matrix elements updated by the leg point clouds of the legged robot, the number of rows ranges from r₁ to r₂, the number of columns ranges from c₁ to c₂, and the corrosion size s is set according to sizes of the legs;
S52, performing protrusion corrosion within a set range to remove terrain protrusions caused by the leg point clouds, copying a temporary matrix of the height information matrix, and updating elements in rows from r₁−s to r₂+s and columns from c₁−s to c₂+s of the temporary matrix to a minimum height in rows from −s to s and columns from −s to s around a current element to remove abnormal protrusions of some matrix elements caused by the leg point clouds;
S53, performing expansion compensation on a normal terrain, and updating the elements in the rows from r₁−s to r₂+s and the columns from c₁−s to c₂+s of the temporary matrix to a maximum height in the rows from −s to s and the columns from −s to s around the current element to compensate for a change of the normal terrain caused by S52; and
S54, updating the height information matrix, and copying a region defined by rows from r₁ to r₂ and columns from c₁ to c₂ in the temporary matrix to the original height information matrix.

7. The local terrain perception method for legged robots according to claim 1, wherein S6 comprises following sub-steps:
S61, calculating a slope component in an x-direction of each element in the matrix, defining an m*m x-direction slope information matrix, looping through the height information matrix obtained in S5, and calculating a slope component slopeₓ in the x-direction of each element with a height:
$${slope}_{x} = \frac{( {slope}_{x 1} + {slope}_{x 2} )}{2}$$
$${slope}_{x 1} = \frac{h ( i , j ) - h ( i - 1 , j )}{n}$$
$${slope}_{x 2} = \frac{h ( i + 1 , j ) - h ( i , j )}{n}$$
where, n denotes a width of a square grid corresponding to each element, and h(i,j) is the height of the element in an i^{th} row and a j^{th} column; in a case where h(i−1,j) does not exist or does not have a height and h(i+1,j) has a height, slopeₓ=slopeₓ₂; in a case where h(i+1,j) does not exists or does not have a height and h(i−1,j) has a height, slopeₓ=slopeₓ₁; in a case where h(i−1,j) and h(i+1,j) do not exist or do not have a height, slopeₓ=0;
S62, calculating a slope component in a y-direction of each element in the matrix, defining an m*m y-direction slope information matrix, looping through the height information matrix obtained in S5, and calculating a slope component slope_{y} in the y-direction of each element with a height:
$${slope}_{y} = \frac{( {slope}_{y 1} + {slope}_{y 2} )}{2}$$
$$slop {e}_{y 1} = \frac{h ( i , j ) - h ( i , j - 1 )}{n}$$
$${slope}_{y 2} = \frac{h ( i , j + 1 ) - h ( i , j )}{n}$$
where, n denotes a width of a square grid corresponding to each element, and h(i,j) is the height of an element in an i^{th} row and a j^{th} column; in a case where h(i,j−1) does not exist or does not have a height and h(i,j+1) has a height, slope_{y}=slope_{y2}; in a case where h(i,j+1) does not exists or does not have a height and h(i,j−1) has a height, slope_{y}=slope_{y1}; in a case where h(i,j−1) and h(i,j+1) do not exist or do not have a height, slope_{y}=0;
S63, calculating an actual slope of each element in the matrix, defining an m*m actual slope information matrix, and updating the actual slope information matrix with the x-direction slope information matrix and the y-direction slope information:
slope(i,j)={square root over ((slopeₓ(i,j))²+(slope_{y}(i,j))²)}
where, slope(i,j) is a slope of an element in an i^{th} row and a j^{th} column of the actual slope information matrix, and slopeₓ(i,j) and slope_{y}(i,j) are respectively a slope of the element in the i^{th} row and the j^{th} column of the x-direction slope information matrix and a slope of the element in the i^{th} row and the j^{th} column of the y-direction slope information matrix;
S64, defining an m*m obstacle information matrix, and presetting a maximum walking step length l_Max, a maximum foothold height h_Max and a maximum foothold slope s_Max of the legged robot;
S65, calculating offline a matrix element access sequence in an obstacle analysis process; and
S66, sequentially accessing corresponding elements in the height information matrix and the slope information matrixes according to the access sequence obtained in S65, and analyzing whether grids where the elements are located are obstacles.

8. The local terrain perception method for legged robots according to claim 7, wherein in S65, with a center of the obstacle information matrix as a starting point, multiple search directions are preset and cover a 360° range; according to a size of the matrix, a search width in each search direction is preset as w, and a search step is set as n and is consistent with the width of the grid corresponding to one element; in each search direction, a segment which has a midpoint located at the center of the matrix and a width w and is perpendicular to the search direction is obtained first, and matrix elements corresponding to all grids where the segment passes are search elements obtained of step 0; and every time one search step is completed, the segment is moved by one step n in the search direction, elements corresponding to grids where the moved segment passes are search elements of a new step, and searching in each search direction will not be ended until the segment is moved completely out an area where the matrix is located.

9. The local terrain perception method for legged robots according to claim 7, wherein in S66, at the beginning of searching in each search direction, a historical search queue is established first, wherein a maximum length of the queue is l_queue=l_Max/n, is rounded down and indicates search steps corresponding to the maximum walking step length of the legged robot, and when a new value is added to a tail of the queue and the queue exceeds the maximum length, a value at a head of the queue will be deleted.

10. The local terrain perception method for legged robots according to claim 9, wherein in S66, an initial height is set as a zeroth value of the queue, wherein the initial height is an opposite number of a height of the legged robot standing on the ground; for a plurality of grids searched in each step, if a total height of the grids is greater than a maximum value+h_Max in the historical search queue, it is determined that the grids are obstacles, and corresponding elements of the obstacle information matrix are marked as 1; if the total height of the grids is less than or equal to the maximum value+h_Max in the historical search queue, it is determined that the grids are passable and are not obstacles, and in this case, if a corresponding slope is less than s_Max, it is determined that the grids are footholds, and the corresponding elements of the obstacle information matrix are marked as 0; if the corresponding slope is greater than s_Max, it is determined that the grids are passable and are not footholds, and the corresponding elements of the obstacle information matrix are marked as 0.1; and every time one search step is completed, a maximum height of all grids determined as footholds is added to the tail of the historical search queue.
